(19) United States
(12) Patent Application Publication
(10) Pub. No.: US 2006/0109924 A1
(43) Pub. Date: May 25, 2006

(54) Apparatus and method for signal transmission/reception according to pilot modulation in a multi-carrier communication system

(75) Inventors: Jin-Kyu Koo, Suwon-si (KR); Chang-Ho Suh, Seongnam-si (KR); Seung-Hoon Park, Seoul (KR); Young-Kyun Kim, Seongnam-si (KR); Dong-Seek Park, Yongin-si (KR); Jung-Min Ro, Seoul (KR); Sung-Kwon Hong, Seoul (KR); Young-Kwon Cho, Suwon-si (KR)

Correspondence Address: DILWORTH & BARRESE, LLP, 333 EARLE OVINGTON BLVD., UNIONDALE, NY, 11553, US

(73) Assignee: Samsung Electronics Co., Ltd., Suwon-si (KR)

(21) Appl. No.: 11/284,321

(22) Filed: Nov. 21, 2005

(30) Foreign Application Priority Data
Nov. 19, 2004 (KR) 2004/95092

(51) Int. Cl. H04K 1/10

(52) U.S. Cl. 375/260

(57) ABSTRACT

Disclosed is a system and method for modulating a pilot symbol sequence in a multi-carrier communication system. The method including producing a pilot symbol sequence corresponding to a predetermined time interval by removing a data symbol sequence from time domain signal to be transmitted, the time domain signal including the data symbol sequence and the pilot symbol sequence; and modulating the pilot symbol sequence so that a part of the time domain signal corresponding to a predetermined number of pilot symbols in the pilot symbol sequence has a predetermined pattern.

### PRIORITY

This application claims priority under 35 U.S.C. §119 to an application filed in the Korean Intellectual Property Office on Nov. 19, 2004 and assigned Serial No. 2004-95092, the contents of which are incorporated herein by reference.

### BACKGROUND OF THE INVENTION

1. Field of the Invention

The present invention relates to signal transmission/reception in a Broadband Wireless Access (BWA) communication system, and more particularly to an apparatus and a method for transmitting/receiving a signal in accordance with pilot modulation in a multi-carrier communication system.

2. Description of the Related Art

An Orthogonal Frequency Division Multiplexing (OFDM) scheme, which transmits data using multiple carriers, is a special type of a Multiple Carrier Modulation (MCM) scheme in which a serial symbol sequence is converted into parallel symbol sequences and the parallel symbol sequences are modulated with a plurality of mutually orthogonal subcarriers (or subcarrier channels) before being transmitted.

Multiple access schemes based on the OFDM scheme include an Orthogonal Frequency Division Multiple Access (OFDMA) scheme subcarriers are allocated to, and used by, particular terminals.

A communication system using the OFDMA scheme also uses insertion of a guard interval into each OFDMA symbol period in order to reduce the effects of inter symbol interference (ISI). More specifically, the guard interval is inserted to remove interference between a previous OFDMA symbol transmitted at a previous OFDMA symbol time and a current OFDMA symbol to be transmitted at a current OFDMA symbol time in an OFDM communication system.

Moreover, null data is inserted into the guard interval. In this case, however, when a receiver incorrectly estimates a start point of an OFDMA symbol, interference occurs between subcarriers, causing an increase in the incorrect estimation rate for the received OFDMA symbol. Therefore, a cyclic prefix (CP) method or a cyclic postfix method is used. In the cyclic prefix method, a predetermined number of last bits of an OFDMA symbol in a time domain are copied and inserted into a valid OFDMA symbol. In the cyclic postfix method, a predetermined number of first bits of an OFDMA symbol in a time domain are copied and inserted into a valid OFDMA symbol.

Although the insertion of the guard interval is effective in overcoming the ISI and the inter-carrier interference (ICI), it wastes resources and reduces the bandwidth efficiency by a quantity corresponding to (guard interval/symbol period), thereby lowering the signal-to-noise ratio (SNR). Therefore, a solution capable of solving the ISI or ICI problem without using the CP copied from a predetermined number of last bits of an OFDMA symbol and inserted into a valid OFDMA symbol is necessary. Further, such a solution without using the CP is necessary in order to increase the bandwidth efficiency.

### SUMMARY OF THE INVENTION

Accordingly, the present invention has been made to solve the above-mentioned problems occurring in the prior art, and an object of the present invention is to provide a method and a transmission/reception apparatus, which can reduce inter-symbol interference (ISI) or inter-carrier interference (ICI) without using a conventional cyclic prefix scheme (CP) and thereby increase the bandwidth efficiency.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating a structure of a transmitter of an OFDMA/CDM communication system according to an embodiment of the present invention;

FIG. 2 is a graph illustrating data symbols and pilot symbols mapped to the frequency axis after being spread according to an embodiment of the present invention;

FIG. 3 is a block diagram illustrating a structure of a transmitter of an OFDMA/CDM communication system according to an embodiment of the present invention;

FIG. 4 is a flowchart illustrating an operation process of the pilot symbol operator according to an embodiment of the present invention; and

FIG. 5 is a flowchart illustrating an operation process of the output controller according to an embodiment of the present invention.

### DETAILED DESCRIPTION OF THE PREFERRED EMBODIMENT

Hereinafter, preferred embodiments of the present invention will be described with reference to the accompanying drawings. In the following description, a detailed description of known functions and configurations incorporated herein will be omitted when it may make the subject matter of the present invention unclear.

The present invention proposes a solution which generates a predetermined pattern for some Orthogonal Frequency Division Multiple Access (OFDMA) symbols in a time domain by modulating the pilot in a different manner according to data in a communication system using multi-carriers, so as to eliminate the necessity for insertion of the guard interval between adjacent OFDMA symbols.

Usually in a communication system using multi-carriers, in order to effectively reduce an ISI and ICI, several last samples of an Inverse Fast Fourier Transform (IFFT) output of a transmitter are copied and the copied samples are then attached to the front of an IFFT output, thereby generating a guard interval, e.g., a cyclic prefix (CP). However, such insertion of the CP wastes system resources.

In order to reduce or entirely eliminate this waste of system resources, the CP can be eliminated. Accordingly, if a predetermined number of last samples of all OFDMA symbols have a predetermined value regardless of data (i.e., if a predetermined number of last samples of all OFDMA symbols have the same pattern), it is unnecessary to add a separate CP because the predetermined number of last samples of a previous OFDMA symbol can function just as the conventional CP for an OFDMA symbol at any given instant.

However until now, it is difficult or impossible to directly apply the above-stated method to an OFDMA system (OFDMA/CDM system) using a Code Division Multiplexing (CDM) scheme. Accordingly, an apparatus and a method according to the present invention which is capable of solving the above-noted problems will now be described.

The communication system using multi-carriers proposed by the present invention is preferably an OFDMA/CDM communication system. Specifically, the OFDMA/CDM communication system is a system in which data and pilots are spread/de-spread and transmitted/received for every predetermined number of sub-carriers. For example, when data and pilots are spread and transmitted for every M sub-carriers, (M-1) data and one pilot can be spread by using a spread code having a length of M allocated to each of them (Here, the M is integer).

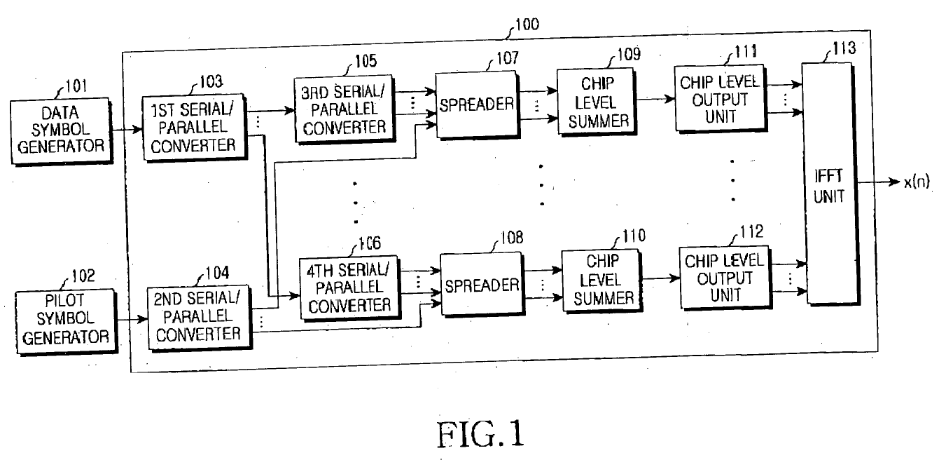

First, a structure of a transmitter of an OFDMA/CDM communication system according to an embodiment of the present invention will be described with reference to FIG. 1.

FIG. 1 shows a block diagram illustrating a structure of a transmitter of an OFDMA/CDM communication system according to an embodiment of the present invention. A data symbol generator 101 generates a data symbol during a predetermined symbol period and outputs the generated data symbol to a first serial/parallel converter 103. The first serial/parallel converter 103 converts the data symbol input from the data symbol generator 101 into parallel branch symbols corresponding to D (D is an integer) branches and outputs the branch symbols to the third˜fourth serial/parallel converters 105-106. Each of the third-fourth serial/parallel converters 105-106 converts each of the respectively input branch symbols into (M-1) number of parallel symbols and outputs the converted (M-1) parallel symbols to (M-1) number of spreaders 107-108.

Also, a pilot symbol generator 102 generates a pilot symbol during a predetermined symbol period and outputs the generated pilot symbol to a second serial/parallel converter 104. The serial/parallel converter 104 converts the pilot symbol input from the data symbol generator 101 into parallel symbols corresponding to D branches and outputs the parallel symbols to the spreaders 107-108.

Each of the spreaders 107-108 spreads the (M-1) data symbols input from the third-fourth serial/parallel converters 105-106 and the single pilot symbol input from the second serial/parallel converter 104 by using an orthogonal code having a length of M. In this case, because there exist D (where D is an integer) sets of (M-1) data symbols and one pilot symbol, the transmitter includes D number of spreaders 107-108.

The symbols spread by the spreaders 107-108 are input to and then chip-level-added in chip level summers 109-110, respectively. In the chip level addition, chip refers to the code value of each code. For example, if a code is (+1, −1, +1, −1), the two “+1” and the two “−1” are chips of the code. Therefore, the chip level addition is an operation of adding chips of the data and pilots spread by a code.

The signals output from the chip level summers 109-110 are input to chip level output units 111-112 which then output M number of chip levels. Since the transmitter includes D number of chip level output units 111-112, D×M number of chip levels are input to an Inverse Fast Fourier Transform (IFFT) unit 113. The IFFT unit 113 converts the signal in the frequency domain into a signal in the time domain and outputs the signal in the time domain. In the following description, all parts of the transmitter except for the data symbol generator 101 and the pilot symbol generator 102 will be designated by reference numeral “100”.

In order to explain the process for generating an output signal x(n) after the IFFT unit 113, the output signal x(n) can be expressed by Equation 1 below.

$$x ( n ) = {\sum }_{m = 0}^{M - 1} [ \frac{1}{N} {\sum }_{d = 0}^{D - 1} {s}_{d}^{m} ( {\sum }_{k = 0}^{M - 1} {c}_{k}^{m} {ⅇ}^{j2π n ( dM + k ) / N} ) ] \qquad Equation 1$$

In Equation 1, x(n) denotes an output signal of the IFFT unit 113, and n denotes a sub-carrier index having an integer value within a range of 0≦n≦N−1, in which N denotes the number of sub-carriers in the frequency domain and corresponds to DM (N=DM). Also, cₖ^{m} denotes the k^{th} chip value of the m^{th} code from among the M codes, and s_{d}^{m} denotes the d^{th} symbol spread by the m^{th} code. Hereinafter, it is assumed that s_{d}⁰ is a pilot symbol and the others are data symbols.

According to the OFDMA/CDM symbol modulation method according to the present invention, a guard interval (e.g., a CP) is not required because a predetermined number of last samples of the entire symbol x(n) have a predetermined pattern. The predetermined number of last samples having a predetermined pattern serve as a guard interval between adjacent symbols, thereby eliminating the necessity to add a separate guard interval in the data symbol.

According to an alternative embodiment of the present invention, the predetermined number of samples having a predetermined pattern may be front or middle samples as opposed to the last samples. However, for the sake of clarity, the following description deals with only the predetermined number of last samples having a predetermined pattern.

A pilot symbol modulation method in order to make a predetermined number of OFDMA/CDM samples have a predetermined pattern will now be described. First, the difference between a desired sequence pattern x(n) of the time domain and a sequence xₑₚ(n) of the time domain including input data is obtained, and a sequence xₒₚ(n) of the time domain including pilots is then calculated by using the difference between x(n) and xₑₚ(n). When the sequence xₒₚ(n) is obtained through the above calculation, pilots symbols necessary in order to obtain the sequence are extracted through a predetermined operation process.

By using the pilots symbols obtained through the above process, it is possible to make a predetermined number of last samples among the entire OFDMA/CDM symbol always have a predetermined pattern.

Hereinafter, the OFDMA/CDM symbol modulation method for making a predetermined number of last samples among the entire symbol x(n) of the time domain have a predetermined pattern, together with related drawings and equations, will be described in more detail.

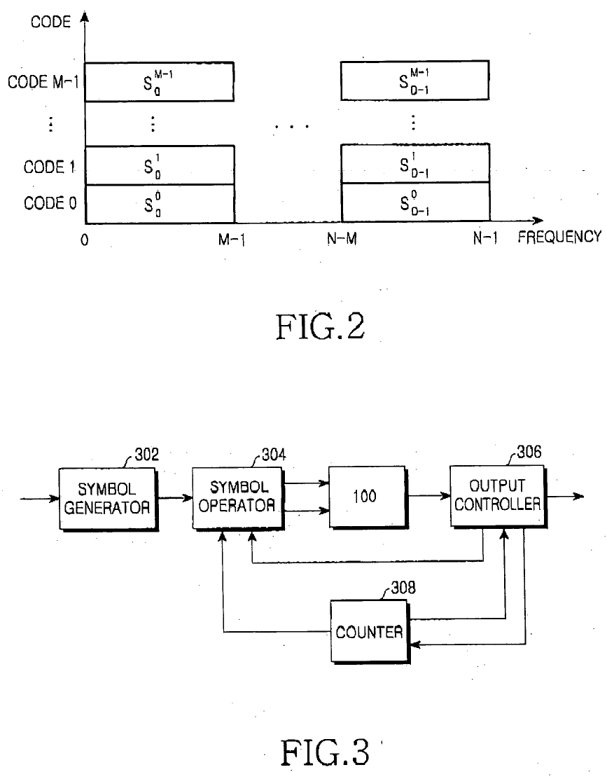

FIG. 2 is a graph illustrating data symbols and pilot symbols mapped to the frequency axis after being spread according to an embodiment of the present invention.

Referring to FIG. 2, the symbols are spread by using orthogonal codes for each frequency band. Hereinafter, description will be given by using equations below.

First, Equation 1 can be simplified into Equation 2 below.

$$x ( n ) = {x}_{ep} ( n ) + {x}_{op} ( n ) \qquad Equation 2$$

In Equation 2, xₑₚ(n) denotes the result of mapping and IFFT of the data symbols (a symbol sequence in the time domain) and can be defined by

$${x}_{ep} ( n ) = {\sum }_{m = 1}^{M - 1} [ \frac{1}{N} {\sum }_{d = 0}^{D - 1} {s}_{d}^{m} ( {\sum }_{k = 0}^{M - 1} {c}_{k}^{m} {ⅇ}^{j2π n ( dM + k ) / N} ) ] , and$$

xₒₚ(n) denotes a result of mapping and IFFT of the pilot symbols (a symbol sequence in the time domain) and can be defined by

$${x}_{op} ( n ) = \frac{1}{N} {\sum }_{d = 0}^{D - 1} {s}_{d}^{0} ( {\sum }_{k = 0}^{M - 1} {c}_{k}^{0} {ⅇ}^{j2π n ( dM + k ) / N} ) .$$

In order to make x(n) be a predetermined signal having a predetermined pattern at a predetermined interval of the signal in the time domain according to an embodiment of the present invention, xₒₚ(n) is obtained by calculating the pilot symbol s_{d}⁰ based on the xₑₚ(n) changing according to the input data symbol.

In other words, in order to make D number of last samples of x(n) according to an embodiment of the present invention, that is, x(N-D), . . . , x(N-1), have a predetermined pattern, values xₒₚ(n) of as defined in Equation 3 below are necessary.

$$[ \begin{matrix}{x}_{op} ( N - D ) \\ ⋮ \\ {x}_{op} ( N - 1 )\end{matrix} ] = [ \begin{matrix}x ( N - D ) - {x}_{ep} ( N - D ) \\ ⋮ \\ x ( N - 1 ) - {x}_{ep} ( N - 1 )\end{matrix} ] \qquad Equation 3$$

In relation to the pilot symbol s_{d}⁰, Equation 3 can be re-expressed by Equation 4 below.

$$[ \begin{matrix}{x}_{op} ( N - D ) \\ ⋮ \\ {x}_{op} ( N - 1 )\end{matrix} ] = [ \begin{matrix}\frac{1}{N} {\sum }_{d = 0}^{D - 1} {s}_{d}^{0} ( {\sum }_{k = 0}^{M - 1} {c}_{k}^{0} {ⅇ}^{j2π ( N - D ) ( dM + k ) / N} ) \\ ⋮ \\ \frac{1}{N} {\sum }_{d = 0}^{D - 1} {s}_{d}^{0} ( {\sum }_{k = 0}^{M - 1} {c}_{k}^{0} {ⅇ}^{j2π ( N - 1 ) ( dM + k ) / N} )\end{matrix} ] \qquad Equation 4$$

By solving Equation 4 by the pilot symbol [s_{d}⁰ . . . s_{D-1}⁰]^{T}, Equation 4 can be re-expressed by Equation 5 below.

$$[ \begin{matrix}{s}_{0}^{0} \\ ⋮ \\ {s}_{D - 1}^{0}\end{matrix} ] = {C}^{- 1} [ \begin{matrix}{x}_{op} ( N - D ) \\ ⋮ \\ {x}_{op} ( N - 1 )\end{matrix} ] \qquad Equation 5$$

In Equation 5, C can be defined by Equation 6 below.

$$C = [ \begin{matrix}\frac{1}{N} {\sum }_{k = 0}^{M - 1} {c}_{( 0 M + k )}^{0} {ⅇ}^{j2π ( N - D ) ( 0 M + k ) / N} & … & \frac{1}{N} {\sum }_{k = 0}^{M - 1} {c}_{( ( D - 1 ) M + k )}^{0} {ⅇ}^{j2π ( N - D ) ( ( D - 1 ) M + k ) / N} \\ ⋮ & ⋰ & ⋮ \\ \frac{1}{N} {\sum }_{k = 0}^{M - 1} {c}_{( 0 M + k )}^{0} {ⅇ}^{j2π ( N - 1 ) ( 0 M + k ) / N} & … & \frac{1}{N} {\sum }_{k = 0}^{M - 1} {c}_{( 0 M + k )}^{0} {ⅇ}^{j2π ( N - 1 ) ( ( D - 1 ) M + k ) / N}\end{matrix} ] \qquad Equation 6$$

By calculating the pilot symbols and applying them to an OFDMA/CDM communication system as shown in Equation 5, it is possible to make the D samples x(N-D), . . . , x(N-1) of the entire data symbol x(n) have a desired pattern. Therefore, it is possible to make D last samples of each OFDMA symbol always have a regular pattern, thereby serving as a CP for the OFDMA symbol. However, because there is no previous OFDMA symbol when an initial OFDMA symbol is transmitted at the time of starting communication, D number of last samples must be copied and inserted as a CP according to the conventional method.

FIG. 3 is a block diagram illustrating a structure of a transmitter of an OFDMA/CDM communication system according to an embodiment of the present invention.

First, a symbol generator 302 generates a data symbol and outputs the generated data symbol to a symbol operator 304. The symbol operator 304 reads a count value of a counter 308. When the read count value is a “0”, the symbol operator 304 passes the data symbol and outputs the data symbol to the first or second serial/parallel converter 103 or 104 of the transmitter 100 shown in FIG. 1. Referring again to FIG. 1, it is noted that the data symbol is input to the first serial/parallel converter 103 and the pilot symbol is input to the second serial/parallel converter 104. However, in the transmitter according to the present invention, because the pilot symbol is generated based on the generated data symbol, it is obvious that the transmitter may use a single integrated serial/parallel converter instead of the first and second serial/parallel converters. Of course, the transmitter of FIG. 1 may include a single serial/parallel converter according to implementation of the entire serial/parallel converter system.

The symbol operator 304 receives time domain signal feedback from an output controller 306. The time domain signal includes data symbol sequences and pilot symbol sequences. From among the input data symbol sequence in the time domain signal, a part corresponding to a predetermined time interval is eliminated to produce a pilot symbol sequence corresponding to the predetermined time interval, and values for a predetermined number of pilot symbols corresponding to the produced pilot symbol sequence are determined.

As described above, when the count value from the counter 308 is “0”, the symbol operator 304 inputs xₑₚ(n) of Equation 2 to the transmitter 100. The output of the transmitter 100 (i.e. an output signal after the IFFT) is input to the output controller 306. When the count value is “0”, the output controller 306 stores the output signal after the IFFT in a memory (not shown) and adds “1” to the count value of the counter 308.

When the count value is “1”, the symbol operator 304 having received the data symbol reads the output signal of the transmitter 100 already stored in the memory and calculates the values of the pilot symbols by using Equation 5. The calculated values of the pilot symbols are input to the transmitter 100. In this case, all of the data symbols in the OFDMA symbols have a null value. That is, only the xₒₚ(n) corresponding to the pilot symbol in Equation 2 is input. The signal output in this way is added to the values (data symbol values) already stored in the memory by the output controller 306 which then finally outputs x(n). The D number of samples x(N-D), . . . , x(N-1) of the signal x(n) output from the output controller 306 have a predetermined pattern which enables the samples to serve as a CP.

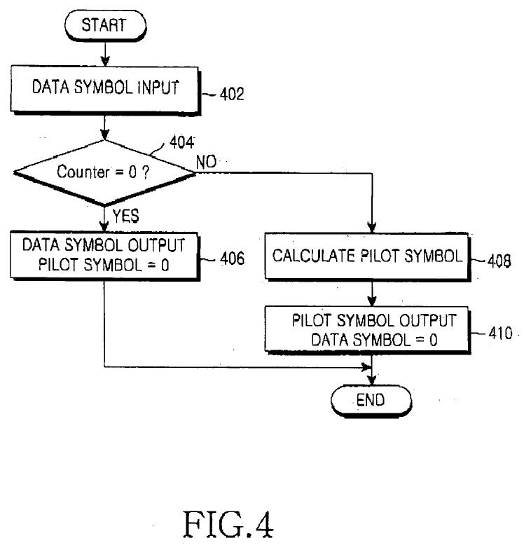

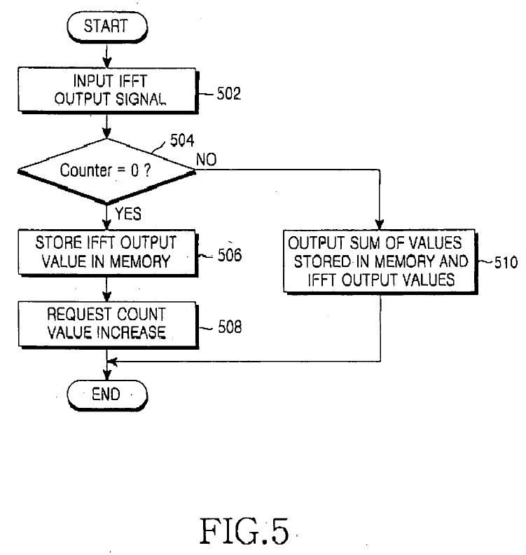

FIG. 4 is a flowchart of an operation process of the pilot symbol operator 304 shown in FIG. 3.

First, in step 402, the symbol operator 304 receives a data symbol. In step 404, the symbol operator 304 reads the count value of the counter 308 and determines if the count value is a “0” or a “1”. As a result of the determination, the process proceeds to step 406 when the count value is “0” and proceeds to step 408 when the count value is

In step 406, the symbol operator 304 passes the input data symbol without processing, and the pilot symbol has a value of “0”. In step 408, the symbol operator 304 calculates the pilot symbol value by using Equation 5 based on the fact that the count value is “1”. In step 410, the xₑₚ(n) corresponding to the data symbol signal is set to “0” and the pilot symbol is output.

FIG. 5 is a flowchart of an operation process of the output controller 306 shown in FIG. 3.

First, in step 502, the output controller 306 receives the output signal after the IFFT operation. In step 504, the output controller 306 reads the count value of the counter 308. The process proceeds to step 506 if it is determined that the count value is “0” and proceeds to step 510 when the count value is “1”. In step 506, based on the fact that the count value is “0”, the output controller 306 stores the output signal after the IFFT in the memory. In step 508, the output controller 306 adds “1” to the count value of the counter 308. In step 510, based on the fact that the count value is “1”, the output controller 306 adds the values already stored in the memory to the output values after the IFFT and outputs the added values.

The output controller 306 according to an embodiment of the present invention serves as a modulator which modulates the pilot symbol sequence by using the pilot symbol values so that a predetermined number of samples located at predetermined time intervals in the entire transmitted signal have an identical pattern. Meanwhile, it goes without saying that the modulator (not shown) may be separately connected to the output controller 306 instead of being including in the output controller 306.

An OFDMA/CDM communication system according to the present invention does not use a CP as a guard interval as used by conventional systems. Instead, in the OFDMA/CDM communication system according to the present invention, a predetermined number of last samples of an OFDMA symbol have a predetermined pattern which enables the samples to serve as a guard interval, thereby eliminating interference such as ISI or ICI. Therefore, the present invention can increase bandwidth efficiency.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for modulating a pilot symbol sequence in a multi-carrier communication system, the method comprising the steps of:
producing a pilot symbol sequence corresponding to a predetermined time interval by removing a data symbol sequence from time domain signal to be transmitted, he time domain signal including the data symbol sequence and the pilot symbol sequence; and
modulating the pilot symbol sequence so that a part of the time domain signal corresponding to a predetermined number of pilot symbols in the pilot symbol sequence has a predetermined pattern.

2. The method as claimed in claim 1, wherein the data symbol sequence and the pilot symbol sequence of the time domain are determined by:
converting input data symbols and pilot symbols into parallel symbols;
spreading the converted parallel symbols by using orthogonal codes having a predetermined length;
summing the spread symbols; and
performing an Inverse Fast Fourier Transform (IFFT) operation on the summed symbols so that the summed symbols are distributed to branches having the predetermined length.

3. The method as claimed in claim 1, wherein the pilot symbol sequence having the predetermined pattern is obtained by calculating a time domain symbol sequence defined by
$$[ \begin{matrix}{x}_{op} ( N - D ) \\ ⋮ \\ {x}_{op} ( N - 1 )\end{matrix} ] = [ \begin{matrix}\frac{1}{N} {\sum }_{d = 0}^{D - 1} {s}_{d}^{0} ( {\sum }_{k = 0}^{M - 1} {c}_{k}^{0} {ⅇ}^{j2π ( N - D ) ( dM + k ) / N} ) \\ ⋮ \\ \frac{1}{N} {\sum }_{d = 0}^{D - 1} {s}_{d}^{0} ( {\sum }_{k = 0}^{M - 1} {c}_{k}^{0} {ⅇ}^{j2π ( N - 1 ) ( dM + k ) / N} )\end{matrix} ] ,$$
which changes according to an input data symbol sequence, wherein
xₒₚ denotes a time domain symbol sequence obtained by performing IFFT on the pilot symbol sequence, N denotes the number of all sub-carriers, D denotes an integer value, s_{d}^{m} denotes the d^{th} pilot symbol spread by the m^{th} code from among M codes, and cₖ^{m} denotes the k^{th} chip value of the m^{th} code from among M spread orthogonal codes.

4. An apparatus for modulating a pilot symbol sequence in a multi-carrier communication system, the apparatus comprising:
a symbol operator for producing a pilot symbol sequence corresponding to a predetermined time interval by removing a data symbol sequence from a time domain signal to be transmitted, and determining a predetermined number of pilot symbols in the produced pilot symbol sequence to have a predetermined pattern in the time domain signal, the time domain signal including the data symbol sequence and the pilot symbol sequence; and
an output controller for modulating the pilot symbol sequence so that a predetermined number of samples located in a predetermined time interval in the entire time domain signal have a predetermined pattern.

5. The apparatus as claimed in claim 4, further comprising:
serial/parallel converters for converting input data symbols and pilot symbols into parallel symbols;
spreaders for spreading the converted parallel symbols by using orthogonal codes having a predetermined length;
summers for summing the spread symbols; and
an Inverse Fast Fourier Transform (IFFT) unit for performing an IFFT operation on the summed symbols so that the summed symbols are distributed to branches having the predetermined length.

6. The apparatus as claimed in claim 4, wherein the pilot symbol sequence having the predetermined pattern is obtained by calculating a time domain symbol sequence defined by
$$[ \begin{matrix}{x}_{op} ( N - D ) \\ ⋮ \\ {x}_{op} ( N - 1 )\end{matrix} ] = [ \begin{matrix}\frac{1}{N} {\sum }_{d = 0}^{D - 1} {s}_{d}^{0} ( {\sum }_{k = 0}^{M - 1} {c}_{k}^{0} {ⅇ}^{j2π ( N - D ) ( dM + k ) / N} ) \\ ⋮ \\ \frac{1}{N} {\sum }_{d = 0}^{D - 1} {s}_{d}^{0} ( {\sum }_{k = 0}^{M - 1} {c}_{k}^{0} {ⅇ}^{j2π ( N - 1 ) ( dM + k ) / N} )\end{matrix} ] ,$$
which changes according to an input data symbol sequence, wherein,
xₒₚ denotes a time domain symbol sequence obtained by performing an IFFT on the pilot symbol sequence, N denotes the number of all sub-carriers, D denotes an integer value, s_{d}^{m} denotes the d^{th} pilot symbol spread by the m^{th} code from among M codes, and cₖ^{m} denotes the k^{th} chip value of the m^{th} code from among M spread orthogonal codes.

7. The apparatus as claimed in claim 4, wherein the symbol operator separately transmits the data symbol and the pilot symbol based on a predetermined count value, wherein:
the pilot symbol is set to null and the data symbol is output when the count value is equal to “0”; and
the data symbol is set to null and the pilot symbol is output after being calculated when the count value is equal to “1”.

8. The apparatus as claimed in claim 4, wherein the output controller receives an output signal after the IFFT operation and transmits an output value based on a predetermined count value, wherein:
the output controller stores the output signal after the IFFT operation and increases the count value when the count value is equal to “0”; and
the output controller sums stored data symbol values and the output signal after the IFFT operation and then outputs the sum when the count value is equal to “1”.

9. A method for modulating a pilot symbol sequence in a multi-carrier communication system, the method comprising the steps of:
receiving a symbol sequence including a data symbol sequence and a pilot symbol sequence in a time domain;
obtaining the pilot symbol sequence by eliminating the data symbol sequence from the symbol sequence;
extracting a predetermined number of pilot symbols from among the obtained pilot symbol sequence; and
modulating the extracted pilot symbol so that the extracted pilot symbol sequence has the predetermined pattern.

10. The method as claimed in claim 9, wherein the pilot symbol sequence of the time domain is generated to have the predetermined pattern at a predetermined position.

11. The method as claimed in claim 9, wherein the pilot symbol sequence having the predetermined pattern is obtained through calculation of a time domain symbol sequence defined by,
$$[ \begin{matrix}{x}_{op} ( N - D ) \\ ⋮ \\ {x}_{op} ( N - 1 )\end{matrix} ] = [ \begin{matrix}\frac{1}{N} {\sum }_{d = 0}^{D - 1} {s}_{d}^{0} ( {\sum }_{k = 0}^{M - 1} {c}_{k}^{0} {ⅇ}^{j2 π ( N - D ) ( dM + k ) / N} ) \\ ⋮ \\ \frac{1}{N} {\sum }_{d = 0}^{D - 1} {s}_{d}^{0} ( {\sum }_{k = 0}^{M - 1} {c}_{k}^{0} {ⅇ}^{j2 π ( N - 1 ) ( dM + k ) / N} )\end{matrix} ] ,$$
which changes according to an input data symbol sequence, wherein
xₒₚ denotes a time domain symbol sequence obtained by performing Inverse Fast Fourier Transform (IFFT) on the pilot symbol sequence, N denotes the number of all sub-carriers, D denotes an integer value, s_{d}^{m} denotes the d^{th} pilot symbol spread by the m^{th} code from among M codes, and cₖ^{m} denotes the k^{th} chip value of the m^{th} code from among M spread orthogonal codes.

12. The method as claimed in claim 9, further comprising the step of separately transmitting the data symbols and the pilot symbols based on a predetermined count value, wherein:
the pilot symbol is set to be null and the data symbol is intactly output when the count value is “0”; and
the data symbol is set to be null and the pilot symbol is output after being calculated when the count value is “1”.

13. The method as claimed in claim 9, further comprising the step of receiving an output signal after the IFFT operation and transmitting an output value based on a predetermined count value, wherein:
the output controller stores the output signal after the IFFT operation and increases the count value when the count value is equal to “0”; and
the output controller sums stored data symbol values and the output signal after the IFFT operation and then outputs the sum when the count value is “1”.
